(19) United States
(12) Patent Application Publication
(10) Pub. No.: US 2025/0183325 A1
(43) Pub. Date: Jun. 5, 2025

(54) PSEUDO-BOEHMITE ALOOH/NGR COMPOSITE-BASED AIR ELECTRODE FOR MECHANICALLY RECHARGEABLE ZN-AIR BATTERY APPLICATIONS

(71) Applicant: COUNCIL OF SCIENTIFIC AND INDUSTRIAL RESEARCH, New Delhi (IN)

(72) Inventors: Geeta Pandurang KHARABE, Pune (IN); Ayasha NADEEMA, Pune (IN); Narugopal MANNA, Pune (IN); Santosh Kumar SINGH, Pune (IN); Sreekumar KURUNGOT, Pune (IN)

(21) Appl. No.: 18/845,169

(22) PCT Filed: Mar. 2, 2023
(86) PCT No.: PCT/IN2023/050195

§ 371 Date: Sep. 9, 2024

(30) Foreign Application Priority Data
Mar. 7, 2022 (IN) 202211012420

(51) Int. Cl. H01M 4/90; H01M 4/86; H01M 12/08

(52) U.S. Cl. CPC H01M 4/9016; H01M 4/8605; H01M 12/08

(57) ABSTRACT

The present invention provides a transition metal-free electrocatalyst (AlOOH/NGr), comprising of monodispersed aluminium oxyhydroxide (AlOOH) sheets anchored over the electronically conducting nitrogen-doped graphene (NGr), for ORR (Oxygen reduction reaction). The AlOOH/NGr possesses good catalytic durability in alkaline medium. The invention further provides synthesis of AlOOH/NGr and its applications in an air electrode for fabricating a primary Zn-air battery.

### FIELD OF THE INVENTION

The present invention relates to AlOOH/NGr (aluminium oxyhydroxide/nitrogen-doped graphene) based air electrode for zinc air battery applications. More particularly, the present invention relates to AlOOH/NGr composite-based air electrode for mechanically rechargeable zinc-air batteries (ZABs).

### BACKGROUND OF THE INVENTION

A variety of battery technologies based on ion chemistry, sulphur chemistry, nickel-metal hydride chemistry, lead-acid chemistry, and metal-air chemistry have been explored from time to time. Among them, the Zn-air battery chemistry has multiple advantages: higher energy density, safe operation and low cost to make them viable contenders in the current sustainable energy generation and storage scenario. However, their commercialization is still limited by a few hurdles to look into, for instance, high cost and fast degradation of the cathode material, which catalyses the complex oxygen reduction reaction (ORR) involving the 4e−/4H⁺ transfer process (O₂+2H₂O+4e−→4OH—). So far, precious Pt-based electrocatalytic materials have been considered a benchmark for the sluggish ORR kinetics. However, the low abundance and limited cycle life of Pt-based systems have diverted the research focus toward developing Pt-free electrocatalysts. Extensive research has been done on transition metal oxides, hydroxides, and oxy-hydroxides of Co, Mn, Fe, and Ni, to make them competitive ORR electrocatalysts. However, the associated toxicity and lower abundance of many of these metals compared to the main group p-block elements restrict their scope for large-scale utilizations in energy technologies. Furthermore, the higher lattice mismatch of the 3d orbitals of the transition metals with the 2p orbitals of the conducting support (mainly carbon) affects the metal-support interactions, which ultimately influences the overall catalytic performance (Nature Materials, 2015, 14, 937-942). Another important setback associated with the transition metal catalysts is the parasitic reaction, i.e., parasitic Fenton reaction, which significantly affects the durability of the electrocatalysts as well as solid electrolytes in the integrated assemblies (Chemical Engineering Journal, 2021 DOI: https://doi.org/10.1016/j.cej.2021.133767, 133767).

In this context, the main group elements-based electrocatalysts are gaining generous attention as a new class of electrocatalysts due to their associated properties such as presence of vacant 2p orbital, abundant availability and eco-friendliness (The Journal of Physical Chemistry C, 2016, 120, 26435-26441). The presence of vacant p-orbitals of these elements establishes strong interaction with the 2p orbitals of the carbon and the N-doped carbon supports (ACS Catalysis, 2019, 9, 610-619). Further, various DFT studies have suggested that the vacant 2p orbitals of the main group elements promote the kinetics of the ORR activity by altering the binding energy of the oxygen adsorption and desorption processes. Though p-block elements show numerous associated positive properties, they have been the least explored materials towards electrocatalytic applications due to their comparatively less conductivity and oxide formation tendency. However, there are reports where p-block metals are hybridized with suitable conducting materials and exhibited good catalytic performance toward various electrochemical reactions. The metal-air battery has gained significant attention as an alternative to conventional energy sources due to its high theoretical energy density compared to that of lithium-ion batteries. Among the various metal-air battery technologies, the zinc-air battery (ZAB) has gained renewed interest due to its high energy density, low cost, great safety, and environmental friendliness. The most important component in metal-air batteries is the electrocatalyst, which facilitates the sluggish oxygen reduction reaction (ORR). Electrocatalyst dependency on expensive noble metals such as Pt, obstruct their large-scale application. Moreover, their commercialization has been impeded by the lack of robust, low-cost and environmentally benign catalyst materials that can be easily scaled up. Further, there are studies reporting the potential of metal oxyhydroxides toward catalysing oxygen reduction reaction (RSC Advances, 2016, 6, 29848-29854 and Journal of Materials Chemistry A, 2015, 3, 11920-1192).

Therefore, developing low cost, highly active, and stable non-precious metal catalysts is of significant importance considering the techno-commercial viability of the ZAB systems in the battery market. In light of the above, the present invention provides unexplored ORR electrocatalyst which consist of monodispersed aluminium oxyhydroxide (AlOOH) sheets anchored over the electronically conducting nitrogen-doped graphene (NGr).

### Objects of the Invention

Accordingly, it is an objective of the present invention to provide a transition metal-free electrocatalyst (AlOOH/NGr), comprising of monodispersed aluminium oxyhydroxide (AlOOH) sheets anchored over the electronically conducting nitrogen-doped graphene (NGr), for oxygen reduction reaction (ORR).

It is another objective of the present invention to provide a process for synthesis of AlOOH/NGr.

In yet another objective, the invention provides the application of AlOOH/NGr in an air electrode for fabricating a primary zinc-air battery.

### SUMMARY OF THE INVENTION

This summary is provided to introduce a selection of concepts in a simplified format that are further described in the detailed description of the invention.

In a first aspect of the present disclosure, the present invention provides a transition metal-free electrocatalyst composite, comprising: aluminium oxyhydroxide/nitrogen-doped graphene (AlOOH/NGr), wherein monodispersed aluminium oxyhydroxide (AlOOH) sheets anchored over an electronically conducting nitrogen-doped graphene (NGr), wherein the AlOOH/NGr comprises thin layered phase of AlOOH nanosheets uniformly distributed over NGr, wherein the AlOOH/NGr comprises aluminium, oxygen, nitrogen and carbon, wherein aluminium and oxygen are distributed in a leaf like shape in the AlOOH/NGr, and wherein nitrogen and carbon are distributed uniformly in the AlOOH/NGr.

In an embodiment, the present invention provides a transition metal-free electrocatalyst composite, wherein aluminum is present in an amount of from 6.2 to 9.7 wt % of the total wt % of the composite; wherein oxygen is present in an amount of from 14.9 to 18.1 wt % of the total wt % of composite; and wherein nitrogen is present in an amount of from 7 to 12.2 wt. % of the total wt. % of composite.

In an embodiment, the present invention provides a transition metal-free electrocatalyst composite, wherein the AlOOH/NGr displays an oxygen reduction reaction onset potential of 0.83 V; and a half-wave potential of 0.72±2V.

In an embodiment, the present invention provides a transition metal-free electrocatalyst composite, wherein the AlOOH/NGr displays mesoporosity in a range of about 5-10 nm and about 12-32 nm.

In an embodiment, the present invention provides a transition metal-free electrocatalyst composite, wherein the AlOOH nanosheets comprise a width in a range of about 150-200 nm.

In another aspect of the present disclosure, the present invention provides a process for the synthesis of the transition metal-free electrocatalyst composite as claimed in claim 1 by a one pot hydrothermal process, the process comprises the steps of: a. providing graphene oxide in an amount of 60-65 wt %, and Al(NO3)₃·9H₂O in an amount of 35-40 wt %; b. dispersing graphene oxide in water via water-bath sonication followed by addition of Al(NO3)₃·9H₂O and urea under stirring to get a dispersion; and c. hydrothermally heating the dispersion of step b) followed by cooling to room temperature, washing with water, subsequently washing with ethanol and drying to obtain AlOOH/NGr.

In an embodiment, the present invention provides a process for the synthesis of the transition metal-free electrocatalyst composite, wherein the heating is carried out at a temperature of 180° C. for time period of 12 hrs, and wherein the drying is carried out at a temperature of 55° C.

In an embodiment, the present invention provides a process for the synthesis of the transition metal-free electrocatalyst composite, wherein urea is present in an amount of 5 wt. %.

In another aspect of the present disclosure, the present invention provides an air electrode comprising the transition metal-free electrocatalyst composite having AlOOH/NGr.

In an embodiment, the present invention provides an air electrode, wherein the electrode is cathode and composed of AlOOH/NGr, wherein the air electrode of AlOOH/NGr electrocatalyst maintains its performance under four times mechanical recharging of the battery and lasts more than 35 hrs at the discharge current density of 10 mA cm⁻².

In another aspect of the present disclosure, the present invention provides an energy storage device comprising the air electrode.

In an embodiment, the present invention provides an energy storage device, wherein the device is metal-air battery comprising a metal, wherein the metal is zinc, aluminium, or magnesium.

### BRIEF DESCRIPTION OF THE DRAWINGS

FIG. 1 shows field emission scanning electron microscopy (FESEM), transmission electron microscopy (TEM), and high-resolution transmission electron microscopy (HRTEM) analysis of the prepared catalysts; (a) FEESM image of the NGr showing the sheets like morphology; and (b) FEESM image of AlOOH/NGr showing the similar morphology of NGr but the surface is covered with AlOOH nanosheet-like morphology; (c) the TEM images of unsupported AlOOH; (d) the TEM images of AlOOH/NGr recorded at high magnification, (inset: SAED pattern of AlOOH/NGr); (e) HRTEM image of AlOOH/NGr, clearly showing the thin layered structure of AlOOH; (f) zoomed image of AlOOH thin layer, and the inset shows the corresponding d spacing for the (200) and (151) planes.

FIG. 2: shows material characterizations of the prepared electrocatalysts: (a) comparative powder X-ray diffraction (PXRD) patterns of NGr, AlOOH and AlOOH/NGr, (b) comparative Raman spectra of GO, NGr and AlOOH/NGr, (c) TGA profiles of NGr and AlOOH/NGr, and (d) pore size distribution profile of the AlOOH/NGr.

FIG. 3: shows X-ray photoelectron spectroscopy analysis of NGr, AlOOH, and AlOOH/NGr: (a) comparative XPS survey scan spectra of the NGr, AlOOH, and AlOOH/NGr, showing the presence of C, N, O and Al in the respective systems, (b) deconvoluted Al 2p spectra of AlOOH/NGr, (c) deconvoluted O 1s spectra of AlOOH/NGr and (e) deconvoluted N 1s spectra of AlOOH/NGr.

FIG. 4: shows electrochemical analysis of the catalysts in 0.1 M KOH: (a) comparative linear sweep voltammograms (LSVs) of AlOOH, NGr, AlOOH/NGr and Pt/C recorded under O₂ saturated 0.1 M KOH solution at 1600 rpm of W.E and a voltage scan rate of 10 mV sec⁻¹; (b) Tafel plots created for AlOOH/NGr and Pt/C representing the slopes of 95 and 69 mV/dec, respectively; (c) and (d) represent the rotating ring disc electrode (RRDE) data of Pt/C and AlOOH/NGr displaying the amount of H₂O₂ generated and the electron transfer number (n-value) corresponding to the ORR process, respectively; (e) and (f) show the LSV profiles recorded before and after the durability analysis of Pt/C and AlOOH/NGr, respectively.

FIG. 5: shows evaluation of the zinc-air battery (ZAB) performance under full-cell configuration by employing AlOOH/NGr as the cathode, 6 M KOH as an electrolyte and zinc foil as an anode: (a) comparative current (I)-voltage (V) polarization plots recorded on the ZABs made with AlOOH/NGr and Pt/C as the air electrodes, (b) comparative galvanostatic discharge profiles recorded corresponding to a current dragging of 10 mA cm⁻² on the ZABs consisting of AlOOH/NGr and Pt/C as the air electrodes, (c) specific capacities calculated from the discharge curve data normalized with the weight of the consumed Zn in both the systems, and (d) mechanically recharged ZAB by replacing the Zn anode with fresh ones after every battery discharge.

FIG. 6: shows SEM-EDS mapping of AlOOH/NGr.

FIG. 7: shows (a) HRTEM image selected for the elemental mapping. Elemental mapping images for C (red), N (green), Al (magenta) and O (blue) elemental overlapping image for C, N, O and Al present in AlOOH/NGr.

FIG. 8. shows (a) BET isotherm of AlOOH/NGr.

FIG. 9: shows XPS analysis: (a) Al 2p spectra of AlOOH, (b) O 1s spectra of AlOOH, (c) N 1s spectra of NGr, (d) C 1s spectra of AlOOH/NGr, and (e) C 1s spectra of NGr.

FIG. 10: shows cyclic voltammograms of (a) Pt/C and (b) AlOOH/NGr, recorded at a scan rate of 50 mV s⁻¹ in N₂-saturated (black line) and O₂-saturated (red line) 0.1 M KOH solution.

FIG. 11: shows (a) RRDE plot for ring and disk current analysis of NGr, AlOOH/NGr and Pt/C catalyst and (b) LSVs recorded before and after the 8000 CV cycles for AlOOH/NGr.

FIG. 12: shows adsorption of AlOOH on rGO and NGr systems: (a) physiosorbed AlOOH on rGO, (b) chemisorbed AlOOH on rGO, (c) chemisorbed AlOOH on NGr, and (d) physiosorbed AlOOH on NGr. Upper panel shows the top and lower panel shows the side view of the systems. The adsorption energies are shown at the bottom.

FIG. 13: shows projected density of states (pDOS) plots for Al(3p) in pristine graphene (red line) and in NGr (blue line). The significant difference in the interaction of Al with rGO and NGr is evident from the pDOS plots.

FIG. 14: shows (a) O2 adsorbed on AlOOH, which desorbs from the pristine graphene sheet, and (b) the O2 molecule adsorbed on AlOOH which is adsorbed on the NGr system. The O—O bond length in the O2 molecule gets activated by more than 6%.

FIGS. 15a and b show the EDX-SEM mapping data of NGr and AlOOH/NGr to estimate the average doping level of N on r-GO. The comparative finding shows the presence of all the concerned elements and that the average doping level of N in r-GO 1s˜21% and in AlOOH/NGr is ˜12%.

FIG. 16: shows TEM analysis: (a) AlOOH/rGO and (b) AlOOH/NGr.

FIG. 17: shows electrochemical analysis of the catalysts in 0.1 M KOH: (a) the LSVs recorded over the catalysts prepared at different reaction durations while maintaining constant reaction temperature of 180° C.; (b) the comparative LSVs of AlOOH·NGr prepared at 120 and 180° C. at the reaction duration of 12 h.

FIG. 18: shows (a) The comparative LSV profiles of AlOOH/NGr and AlOOH/rGO recorded in 0.1 M KOH; (b) the LSV profiles recorded before and after the durability analysis of AlOOH/GO.

FIG. 19: shows (a) Comparative XRD pattern, and (b) TEM image of the cycled catalyst, (inset: SAED pattern).

FIG. 20: shows comparative Nyquist plots recorded for AlOOH/NGr and Pt/C based ZABs under the OCV condition.

FIG. 21: shows schematic representation of the stepwise synthesis of AlOOH/NGr electrocatalyst followed by the air cathode fabrication and ZAB demonstration.

FIG. 22: shows schematic representation of the Zn-air battery.

### DETAILED DESCRIPTION OF THE INVENTION

The invention will now be described in detail in connection with certain preferred and optional embodiments, so that various aspects thereof may be more fully understood and appreciated.

The present invention provides a transition metal-free class of oxygen reduction reaction (ORR) electrocatalyst (AlOOH/NGr), comprising monodispersed aluminium oxyhydroxide (AlOOH) sheets anchored over an electronically conducting nitrogen-doped graphene (NGr). The metal oxyhydroxides, with its positively charged surface originating from the Al metal centre, can further promote the available active sites for oxygen adsorption.

Accordingly, the present invention provides a transition metal-free class of potential ORR electrocatalyst (AlOOH/NGr), by anchoring the pseudo-boehmite phase of aluminium oxyhydroxide (AlOOH) nanosheets over nitrogen-doped graphene (NGr) via a single-step and straightforward hydrothermal process. AlOOH/NGr consisting of thin layered pseudo-boehmite sheets uniformly distributed over NGr that has displayed an oxygen reduction reaction onset potential of 0.83 V and a half-wave potential of 0.72 V, along with good catalytic durability in alkaline medium. The Onset (E) and half-wave (E_{1/2}) potentials recorded for the various synthesized catalysts are shown in table 1 below.

TABLE 1

| | Onset Potential | Half-Wave Potential |
|---|---|---|
| Sample | (V vs. RHE) | (V vs. RHE) |
| NGr | 0.70 V | 0.54 V |
| AlOOH/NGr | 0.83 V | 0.72 V |
| Pt/C | 0.98 V | 0.84 V |

Further, AlOOH/NGr, when used as an air electrode for fabricating a primary Zn-air battery, the system has exhibited an open circuit voltage of ˜1.27 V with a flat discharge profile at the current rate of 10 mA cm⁻². The fabricated system delivered a specific capacity of ˜720 mAh g−1 and a high-power density of 204 mW cm⁻² (as shown in Table 3) which is comparable to the counterpart system based on the state-of-the-art Pt/C (20 wt. % Pt) cathode.

The Comparison of the ORR activities of the reported systems in the literature vs the in-house systems, provided according to the present invention is given in Table 2.

TABLE 2

| | | Onset | Half-Wave | | |
|---|---|---|---|---|---|
| | | Potential | Potential | Tafel | |
| Sr. | Electro | (V vs. | (V vs. | Slope | |
| No. | catalyst | RHE) | RHE) | (mV dec⁻¹) | References |
| 1. | CuPt— | 0.95 V | 0.846 V | ~69.94 | ACS Catalysis 2015, |
| | NC | | | | 5 (3), 1445-1452. |
| 2. | Co/N— | 0.83 V | 0.74 V | — | ACS Appl Mater |
| | C-800 | | | | Interfaces 2016, 8 |
| | | | | | (32), 20730-40 and |
| | | | | | Nanoscale 2014, 6 |
| | | | | | (24), 15080-15089 |
| 3. | AlOOH/ | 0.83 V | 0.72 V | ~69 | Present invention |
| | NGr | | | | |

The comparison of the key performance indicators of the various ZABs reported in the literature with the reported system of the present invention is provided in table 3 below.

TABLE 3

| | | | Specific | | |
|---|---|---|---|---|---|
| | | | capacities | Current | |
| Sr. | Electro- | Power | (mAh/ | densities | |
| No. | catalyst | density | gm-_{Zn}) | (mA/cm²) | References |
| 1. | CoO/N— | 265 mW/ | — | ~200 mA/ | ACS Catalysis |
| | CNT | cm⁻² | | cm² | 2017, 7 (10), |
| | | | | | 6700-6710 |
| 2. | CuPt/NC | — | 560 mAh/ | 20 mA/ | ACS Catalysis |
| | | | g_{Zn} | cm² | 2015, 5 (3), |
| | | | | | 1445-1452. |
| 3. | Co₃O₄/ | 210 mW/ | 490 mAh/ | 10 mA/ | ACS Applied Energy |
| | NEGF | cm² | g_{Zn} | cm² | Materials 2021, |
| | | | | | 4 (5), 4570-4580 |
| 4. | CF—N- | 540 mW/ | 630 mAh/ | 20 mA/ | ACS Appl Mater |
| | rGO-150 | cm² | g_{Zn} | cm² | Interfaces 2016, |
| | | | | | 8 (32), 20730-40 |
| 5. | AlOOH/ | 204 mW/ | 703 mAh/ | 10 mA/ | Present invention |
| | NGr | cm² | g_{-Zn} | cm² | |

Additionally, the homemade battery prepared of the present electrocatalyst was able to maintain its performance under 4 times mechanical recharging of the battery which was lasted for more than 35 h at the discharge current density of 10 mA cm⁻². Thus, the present inventors have provided a potential catalytic system based on an earth-abundant metal for fabricating and demonstrating a robust mechanically rechargeable zinc-air battery.

In another embodiment, the present invention provides AlOOH/NGr which consisting of thin layered pseudo-boehmite sheets uniformly distributed over NGr has displayed an oxygen reduction reaction onset potential of 0.83 V and a half-wave potential of 0.72 V, along with good catalytic durability in alkaline medium.

In yet another aspect, the AlOOH/NGr is prepared by adopting a simple and scalable, one-pot hydrothermal treatment at 180° C., mediated by urea as a reducing as well as a nitrogen doping agent.

Accordingly, the process for the synthesis of AlOOH/NGr comprises:
1. Dispersing graphene oxide (GO) in water via water-bath sonication followed by addition of Al(NO3)₃·9H₂O and 5% Urea under stirring to get the dispersion; and
2. Heating the dispersion of step a) at 180° C. for 12 h; followed by cooling to room temperature, washing with water, ethanol and drying at 55° C. to obtain AlOOH/NGr.

During the synthesis process, initially, Al³⁺ ions get adsorbed over the negatively charged graphene substrate, followed by uniform dispersion of urea over the graphene sheet through electrostatic interaction. Further, on hydrothermal treatment at high temperature, urea decomposes and releases CO₂, NH₂, and OH⁻. Nitrogen released from NH₂ moieties gets doped into the graphene sheet and creates nucleation sites for the metal oxyhydroxide growth. During the decomposition of aqueous solution of urea, slight pH increase generates OH⁻ ions which react with Al³⁺ ions and form Al(OH)₃. As the hydrothermal process proceeds, the initially formed metal ions gradually get nucleated, thus resulting in the formation of the thin layers of leaf-like nanostructured AlOOH anchored over the N-doped reduced graphene oxide. The catalyst (AlOOH/NGr) showed promising ORR activity and durability in 0.1 M KOH. The schematic representation of the stepwise synthesis of AlOOH/NGr electrocatalyst followed by the air cathode fabrication and ZAB demonstration, as shown in FIG. 22.

In an embodiment of the present invention, the amount of GO used ranges from 60%-65%. For example, 60%, 61%, 62%, 63%, 64%, or 65%.

In an embodiment of the present invention, the amount of Al(NO3)₃·9H₂O used ranges from 35%-40%. For example, 35%, 36%, 37%, 38%, 39%, or 40%.

In an embodiment, the morphology of AlOOH/NGr shows layered pseudo-boehmite sheets uniformly distributed over NGr; where anchoring of the pseudo-boehmite phase of aluminium oxyhydroxide (AlOOH) nanosheets over nitrogen-doped graphene (NGr) makes good interaction (2p-2p) between AlOOH and NGr which increases durability of system; and N-doping is helping for better dispersion of AlOOH.

When compared to AlOOH/GO, the AlOOH/NGr of present invention shows good activity as well as durability.

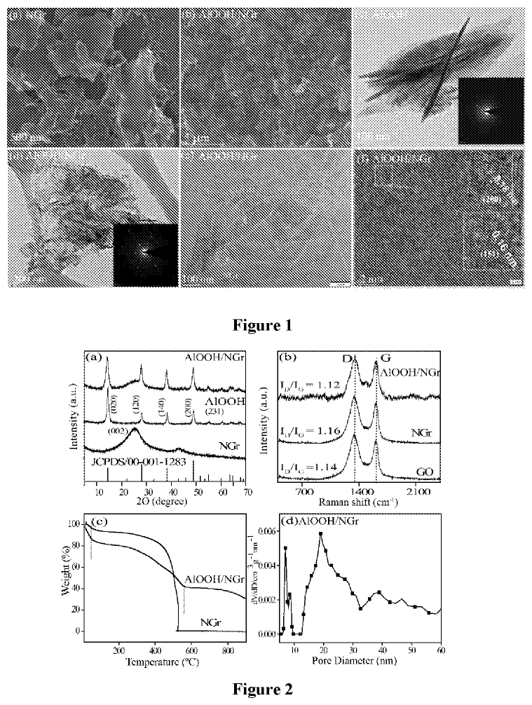

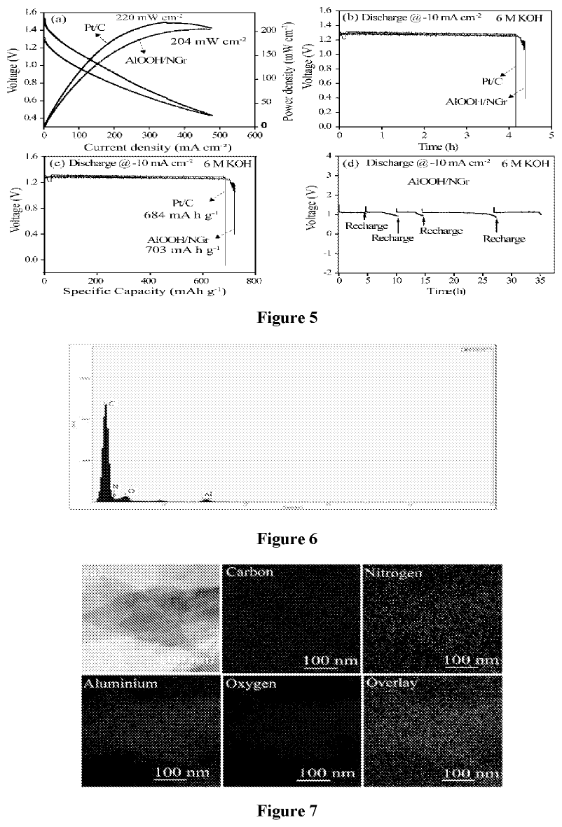

The morphology of the prepared AlOOH/NGr was first analyzed through field-emission scanning electron microscopy (FESEM). FIG. 1a represents the crumpled sheet-like morphology of NGr, formed during the hydrothermal treatment at 180° C. in the presence of urea. FIG. 1b shows the well-dispersed microstructures of the AlOOH over the NGr. Open structure of AlOOH/NGr provides the advantage to facilitate mass transfer of gaseous reactants and products released during the electrochemical processes. FIG. 6 displays the EDX mapping of AlOOH/NGr, which confirms the presence of all the concerned elements with their respective ratio in the catalyst. FIG. 1c represents the TEM image of unsupported AlOOH showing agglomerated leaf-like morphologies due to the uncontrolled nucleation of AlOOH, during hydrothermal treatment in the absence of any support substrate. FIG. 1d shows the TEM image of AlOOH/NGr, displaying thin crumpled sheets of AlOOH anchored over the micro-structured N-doped graphene sheets. The thin and crumpled sheets of AlOOH grown over NGr lead to form a higher surface area catalyst. FIGS. 1 c (Inset), and 1d (Inset) represent the selected area electron diffraction (SAED) pattern of AlOOH and AlOOH/NGr respectively. The SAED pattern for AlOOH, in both AlOOH/NGr, and unsupported AlOOH indicates the presence of a polycrystalline phase of AlOOH. FIG. 1e represents the HRTEM images of AlOOH/NGr, indicating the anchoring of thin layer leaf-like structures of AlOOH over NGr. FIG. 1f includes the zoomed portions of the thin layer of AlOOH with high crystallinity, revealing the lattice fringes of 0.18 nm and 0.16 nm corresponding to the (200) and (151) lattice planes of AlOOH, respectively. FIG. 7 displays the HRTEM elemental mapping images for AlOOH/NGr, depicting that all the elements, i.e., aluminium, oxygen, nitrogen, and carbon are distributed uniformly in the catalyst system.

The phase purity and crystallinity of the NGr, AlOOH, and AlOOH/NGr, nanocomposites were examined by X-ray diffraction (XRD) analysis (FIG. 2a). In the comparative XRD pattern, both NGr as well as AlOOH/NGr exhibit a broad peak centered at a 2θ value of 25.39°, corresponding to the graphitic carbon (002) plane with an interplanar spacing of 0.35 nm. The XRD pattern of the unsupported AlOOH obtained through hydrothermal treatment showed a series of peaks corresponding to (020), (120), (140), (111), (200), (151), (231), and (211) diffraction planes of the pseudo-boehmite AlOOH phase (JCPDS Card No: 00-001-1283), confirming the successful formation of AlOOH moieties during the course of the synthesis. The XRD patterns of AlOOH/NGr showed all the diffraction planes of the pseudo-boehmite AlOOH phase, however, with a slightly negative shift in the diffraction peak compared to the unsupported AlOOH. This is probably due to the interaction of AlOOH with NGr surface. AlOOH/NGr also shows graphitic (002) plane of NGr with diminished intensity.

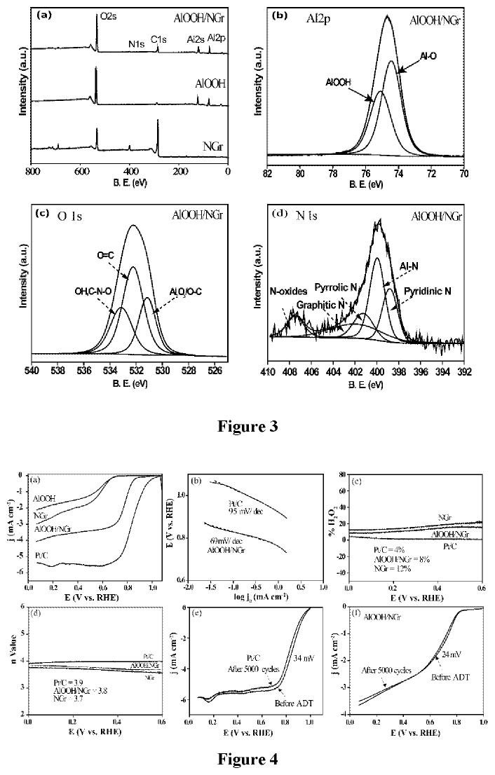

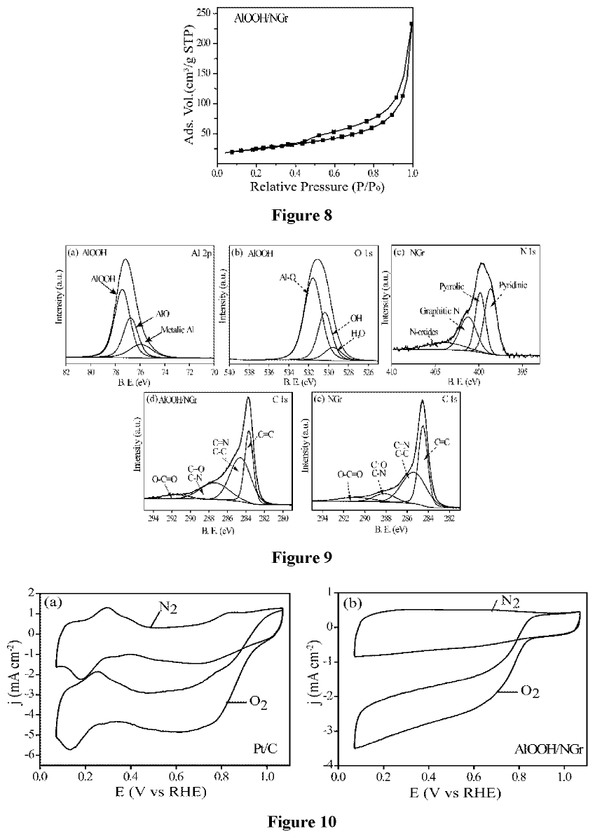

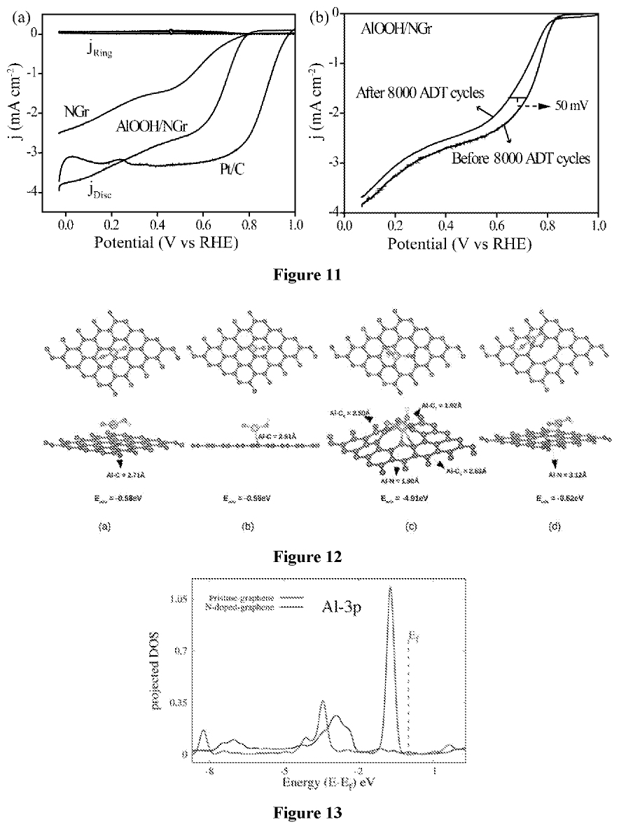

FIG. 2b represents the comparative Raman spectra of GO, NGr, and AlOOH/NGr. The D-band peak appeared at ˜1350 cm⁻¹ resembles to the graphitic lattice vibration mode with the A1g symmetry, while the G band peak centered at 1589 cm⁻¹ corresponds to the E2g symmetry graphitic lattice vibration mode. The ID/IG ratio obtained for NGr and AlOOH/NGr is found to be ˜1.16 and ˜1.14, respectively, which appears to be similar to the corresponding ratio of GO (˜1.12). This similarity in the ID/IG ratio indicates retention of the structure of the nitrogen doped graphitic carbon support after the AlOOH anchoring. The loading of AlOOH over NGr is analyzed by thermogravimetric analysis (TGA) up to 900° C. under oxygen atmosphere. FIG. 2c shows the TGA plots of AlOOH/NGr and NGr. In the case of NGr, a sharp weight loss is observed near 500° C. due to the oxidation of NGr in the form of gaseous CO₂ and NO_{X} species. Contrary to this, AlOOH/NGr displays a two-stage weight loss process, where the first weight loss observed at around 100° C. is ascribed to the evaporation of the physiosorbed water molecules. The second weight loss has been observed as a gradual process and it completes at 550° C. due to the oxidation of NGr. TGA analysis reveals the presence of approximately 35-40% loading of the active material over NGr. Information on the porosity of the catalysts (AlOOH/NGr) has been collected through BET analysis. Accordingly, FIG. 2d and FIG. 8, represent the pore size distribution profile and the BET isotherm of AlOOH/NGr, respectively. FIG. 2d indicates the intense distribution of pores in the range of ˜5-10 nm and ˜12-32 nm region, which confirms the mesoporosity of the composite material. X-ray photoelectron spectroscopy (XPS) measurements were performed to confirm the elemental composition and chemical states of N and C in NGr, Al and O in AlOOH, and Al, O, N, and C in AlOOH/NGr FIG. 3a shows the survey scan spectra of NGr, AlOOH, and AlOOH/NGr showing the presence of the respective elements. From the inset in FIG. 3a, it can be seen that, the Al 2p peak of AlOOH/NGr is slightly shifted towards the lower binding energy region compared to that of AlOOH, which points towards the possible interaction between the NGr support and the AlOOH. FIG. 3b and FIG. 9a, show the deconvoluted Al 2p spectra of AlOOH/NGr and AlOOH, respectively. Deconvoluted Al 2p spectra are fitted in two sub-peaks corresponding to AlOOH and Al—O with the binding energies of 75.1 eV and 74.3 eV, respectively. The comparative binding energy value confirm that, Al is present in the +3 oxidation state with AlOOH enriched surface. The formation of Al—O bond in AlOOH, and AlOOH/NGr is further confirmed by the oxygen deconvolution spectrum. The O 1s deconvolution spectra of AlOOH/NGr in FIG. 3c and of unsupported AlOOH in FIG. 9b, show three sub-peaks corresponding to O═C (532.2 eV), O—H, C—N—O (533.1), and Al2O3, O—C (531.1). FIG. 3d and FIG. 9c, represent the deconvoluted N1s spectra of AlOOH/NGr and NGr. N1s spectra of AlOOH/NGr show five kinds of nitrogen, viz., pyridinic (˜398.8 eV), pyrrolic (˜401.2 eV), graphitic (˜402.2 eV), N—Al (˜399.9 eV), and N-oxide (˜407.0 eV). The percentage of the nitrogen coordinated to Al, i.e., Al—N nitrogen, is found to be more compared to the pyridinic, pyrrolic, graphitic nitrogen, and N-oxide, depicting the AlOOH anchoring through Al—N interaction. In contrast, the N 1s spectra of NGr show all the deconvoluted nitrogen peaks, i.e., pyridinic (˜398.6 eV), pyrrolic (˜399.8 eV), graphitic (˜401.2 eV), and N-oxide (˜403.7 eV), except for the Al—N interaction. Moreover, the deconvoluted C1s spectra of carbon in AlOOH/NGr and NGr (FIGS. 9d, and 9e) show intense fitting of C═C sub-peak at ˜284.4 eV for NGr and ˜284.0 eV for AlOOH/NGr, corroborating the reduction of oxygen functional groups of GO to the graphitic carbon of NGr. Other C 1s sub-peaks of NGr corresponding to the C═N, C—C (˜285.3 eV) and O—C═O (˜291.5 eV) interactions are also visible both in AlOOH/NGr and NGr.

The electrochemical oxygen reduction reaction (ORR) performance of the prepared catalysts was investigated in 0.1 M KOH solution. All the electrochemical analyses were recorded using Hg/HgO as the reference electrode, and the potential was converted to RHE based on the calculation provided in the experimental section. The cyclic voltammograms recorded for AlOOH/NGr and Pt/C at 900 rpm of the working electrode (WE) in O₂ and N₂ atmosphere are shown in FIGS. 10a and 10b. The observed onset potentials corresponding to ORR are 0.83 and 0.98 V for AlOOH/NGr and 20% Pt/C, respectively. For more quantifiable estimation of ORR with respect to the key performance indicators, linear sweep voltammetric (LSV) investigation was performed in O₂ saturated 0.1 M KOH solution at 1600 rpm of the WE, and the corresponding LSV profiles were recorded at a voltage scan rate of 10 mV s⁻¹. FIG. 4a combines the comparative LSVs of NGr, AlOOH, AlOOH/NGr and 20% Pt/C, representing the onset potentials of 0.68, 0.70, 0.83 and 0.98 V, respectively. The measured half-wave potential values for the unsupported AlOOH system, NGr, AlOOH/NGr and 20% Pt/C are 0.53 V, 0.50 V, 0.72 V and 0.85 V, respectively. Though the ORR onset potential of AlOOH/NGr is lower than that of 20 wt. % Pt/C, it is interesting to observe the significant advantage of the synergistic interactions in the ORR kinetics in the case of the nanocomposite system compared to NGr and AlOOH as separate entities. Thus, bringing such controlled interplay of the advantageous characteristics of the interacting moieties through rational designing strategies can help to develop potential cost-effective ORR catalysts. As another key performance indicator, the Tafel slope values are extracted from the plots presented in FIG. 4b for AlOOH/NGr and Pt/C. The Tafel slope values of ˜69 and ˜95 mV dec−1 recorded for AlOOH/NGr and Pt/C, respectively, reveal that AlOOH/NGr show good ORR kinetics even though its Pt-based counterpart system has a clear upper hand. The promising ORR characteristics of AlOOH/NGr compared to AlOOH and NGr is expected to be an outcome of large extent of cooperative interaction existing between NGr and AlOOH. This has been conceived by proper dispersion of AlOOH over NGr. To understand the route of oxygen reduction kinetics involving the desired 4-electron (4e⁻) or the undesirable 2-electron (2e⁻) process, the rotating ring-disc electrode (RRDE) experiment was performed, and the electron transfer number (n) as well as the amount of H₂O₂ formed as a result of the 2e⁻ reduction process has been estimated. Accordingly, FIG. 4c, d, and FIG. 10a, present the data collected from the RRDE studies. The percentile composition of H₂O₂ formed as a function of the applied potential has been measured and the comparative plots presented in FIG. 4c display the values at initial potential as 12, 8, and 4% of H₂O₂ for NGr, AlOOH/NGr, and Pt/C, respectively. The percentage of H₂O₂ formation, which is found to be relatively high (12%) for NGr, has been reduced to 8% in the nanocomposite (AlOOH/NGr), implying to a more favorable shift towards the preferred 4e− oxygen reduction process. Further, the electron transfer number (n) has been deduced, and the corresponding data is presented in FIG. 4d. As can be seen, in the low potential region, the ‘n’ values of NGr, AlOOH/NGr and Pt/C are 3.7, 3.8 and 3.9, respectively. However, the ‘n’ value shows a slow decreasing trend in the case of NGr when the potential approaches towards 0.60 V, whereas AlOOH/NGr is found to be gradually shifting towards the 4e⁻ pathway, after a slow initial decline, in the high potential region. The observed trend in activity and lower % of H₂O₂ is considered to be due to inherent tendency of AlOOH in AlOOH/NGr, which catalyzes peroxide disproportionation reaction.

The durability of the electrocatalyst was evaluated by performing accelerated durability test (ADT) in O₂ saturated 0.1 M KOH solution. The CV analysis was done in the potential window of 0.5-1.3 V (vs. RHE), at a scan rate of 100 mV s⁻¹. Since the operation being done under triggered condition, ADT is expected to provide reliable information on the structural stability of the materials. Comparative LSV profiles have been presented (FIGS. 4e and f) based on the data recorded before and after ADT to investigate the performance change during the targeted catalytic process. From the LSV profiles, subsequent to the 5000 ADT cycles, the half-wave potential (E½) is found to be decreased by 34 and 24 mV for Pt/C and AlOOH/NGr, respectively. The close matching values of the overpotential observed for both Pt/C and AlOOH/NGr after ADT implies promising structural endurance and stability of the active sites incurred by the homemade catalyst. Even after the 8000 ADT cycles, the system could control the reduction in the half-wave potential (E_{1/2}) within 50 mV (FIG. 10b). Higher stability of AlOOH/NGr is credited to the presence of the better corrosion resistive graphitic carbon support in the composite. This is complemented with the important role played by NGr by facilitating the effective dispersion of the thin layers of AlOOH on its surface and immobilizing the moieties by establishing strong surface interactions. The trend obtained during the single-electrode studies for ORR could be reproduced effectively during the demonstration of a full-cell liquid-state ZAB system by employing AlOOH/NGr as the air electrode (cathode). Accordingly, in yet another embodiment, the inventors have fabricated a primary Zn-air battery using the electrocatalyst (AlOOH/NGr) employing 6M KOH solution as the electrolyte and the testing was performed at room temperature. In the pictorial representation of the fabricated ZAB in Scheme 1, a gas diffusion layer (GDL) coated with AlOOH/NGr or 20% Pt/C was employed as the cathode and a Zn foil was served as the anode in a configuration consisting of an active area of 1 cm⁻². In this way, two prototypes for comparative purpose based on AlOOH/NGr and 20 wt. % Pt/C cathodes were fabricated and tested. FIG. 5a shows the comparative I-V polarization plots recorded for the ZABs based on AlOOH/NGr and Pt/C as the air electrodes. ZAB based on AlOOH/NGr as air electrode exhibits an open circuit potential of ˜1.27 V, value which is close to that recorded on counterpart system based on Pt/C (˜1.31 V). In accordance with single-electrode data corresponding to ORR performance evaluations, the demonstration under the full-cell configuration shows a similar trend in the I-V characteristics in entire window of operation as shown in FIG. 5a. Clearly, Pt/C based system has an upper hand in activation polarization region (i.e., in the low current dragging region), which goes in line with difference in ORR performance of these catalysts.

However, the performance difference between the systems is found to be narrowed down as the current dragging increases, and at 0.40 V, both the systems essentially show nearly same level of performance. This important trend infers the efficiency of the AlOOH/NGr system to better manage the Ohmic and mass transfer overpotentials, which pronounced as an important structural attribute of the home-made nanocomposite electrode material. Furthermore, the galvanostatic discharge curves of the AlOOH/NGr and Pt/C based ZABs were recorded at a fixed current dragging of 10 mA cm⁻², and the corresponding comparative plots are presented in FIG. 5b. The discharge time for the ZABs based on AlOOH/NGr and Pt/C are found to be nearly 4.2 and 4.1 h, respectively. The voltage drop in FIG. 5b concerning the operation time is expected to be resulting from the side reactions taking place over the surface of the Zn foil. Further, the specific capacity has been estimated for the systems by taking into account the weight of the consumed Zn in each case (FIG. 5c), and the values are found to be 703 mAh/gzₙ for the system based on AlOOH/NGr and 695 mAh/gzₙ for the counterpart system based on Pt/C. Nearly flat discharge profile recorded by the AlOOH/NGr-based device is a promising aspect of the system concerning the device level durability and reliability in a practical operational perspective. Further, the long-term durability characteristics of the designed catalyst have been validated by performing the demonstration in the mechanically recharging mode of the battery by replacing the used Zn anode with the fresh ones. As shown in FIG. 5d, during the course of this test, the homemade ZAB is able to perform for more than 35 h at the discharge current density of 10 mA/cm² with almost constant OCV value and discharge voltage even after 4 times of the Zn anode replacement. This long-term ZAB performance under the mechanically recharging conditions points towards the promising structural endurance and stable performance characteristics of the air electrode derived from AlOOH/NGr.

Thus, the present invention shows that, with the morphological and electronic modifications, promising activity towards electrochemical oxygen reduction reaction (ORR) can be accomplished in the case of AlOOH, a system which is hither to unexplored for this application. A good dispersion of the pseudo-boehmite AlOOH in the form of nanosheets over nitrogen-doped graphene (AlOOH/NGr) brings in the favourable structural and electronic modulations to enable the system for serving as a promising electrocatalyst for ORR applications. AlOOH/NGr displayed the onset and half-wave (E_{1/2}) potentials of 0.83 and 0.72 V, respectively. These values, even though are lower than that recorded on the state-of-the-art 20 wt. % Pt/C, are promising considering the favourable trend generated as a result of the co-existence of AlOOH and NGr in the nanocomposite. The doped nitrogen in NGr facilitates both strong interaction and effective dispersion of AlOOH, which resulted into fine distribution of AlOOH in the form of nanosheets on the substrate. The controlled interplay between the surface texture and the electronic factors helped to set a trend which favours the ORR performance in AlOOH/NGr, compared to the interacting moieties, viz., NGr and AlOOH, as independent entities. Further, this favour in terms of ORR obtained during the single-electrode studies could be reproduced effectively during the demonstration of a full-cell liquid-state ZAB system by employing AlOOH/NGr as the air electrode (cathode). This cell is found to be fared progressively better as the current dragging increases and the gap in performance between the systems based on the home-made catalyst and Pt/C finally disappears at 0.40 V. This important trend infers the efficiency of the AlOOH/NGr system and its structural attributes to better manage the Ohmic and mass transfer overpotentials. Thus, considering the promising ORR performance, electrochemical stability and structural features to serve as a process-friendly air electrode material, AlOOH/NGr stands out as a potential class of materials for this application and worth exploring for further activity enhancements. Thus, the application of AlOOH/NGr in an air electrode has been successfully demonstrated in a single-cell discharge mode. The activity of the AlOOH/NGr catalyst towards ORR as revealed from the single-electrode studies could be successfully maintained in the system level demonstrations of the ZAB, implying that the Al-based catalysts are worth exploring as a cost-effective and environmentally benign alternatives for the electrochemical energy applications.

### Examples

### Experimental Section

Materials: Aluminum nitrate (Al(NO3)₃·6H₂O), urea (CO(NH₂)₂), potassium hydroxide (KOH), and graphite were procured from Sigma-Aldrich. Ethanol (EtOH) was purchased from Thomas Baker; all the chemicals were used without any further purification.

Example 1: Synthesis of graphene oxide (GO): GO was prepared by using improved Hummer's method. 18 g of KMnO₄ and 3 g of graphite powder were ground well using a mortar and pestle. Afterward complete mixing, the mixture was slowly added to a flask containing a solution mixture of H₂SO₄:H₃PO₄ (9:1) under cold condition. After complete transfer of the solid mixture, the temperature of the solution was increased slowly up to 60° C. and the mixture was kept under stirring for 12 h at the constant temperature. After completion of the reaction, the obtained reaction mixture was slowly poured into crushed ice containing 3% H₂O₂, which appears first to a yellowish solution and subsequently converts to a dark brown solution. It was then washed several times with distilled water via centrifugation at 12000 rpm. The obtained solid residue was further washed with 30% concentrated HCl for the removal of any metal impurities. This solution was again washed with water several times until a neutral pH was achieved. Finally, dark brown-colored, highly viscous solution was obtained, which was further washed with ether and kept in oven for drying at 40° C.

Example: 2: Synthesis of aluminium oxyhydroxide-supported nitrogen-doped graphene (AlOOH/NGr): For the synthesis of AlOOH/NGr, GO was first dispersed in water via water-bath sonication and the mixture was kept for overnight stirring. After the complete dispersion of GO, Al(NO₃)₃·6H₂O was added to the solution, followed by the addition of urea (5% wt.), and the mixture was kept on constant stirring for 2 h to complete the dispersion. After complete mixing, the mixture was transferred to a Teflon-lined autoclave and heat-treated at 180° C. for 12 h; afterward, the autoclave was allowed to cool down naturally to room temperature. Finally, the obtained black-colored solution was filtered and rinsed with deionized water for 5-6 times and subsequently with ethanol for two times to remove the excess unreacted reagents. The obtained black-colored sample was dried at 55° C. for 12 h, and the final sample was designated as AlOOH/NGr.

Example 3: Synthesis of nitrogen-doped graphene (NGr): For the synthesis of NGr, a similar method was used as for AlOOH/NGr, except the addition of Al(NO3)₃·6H₂O.

Example 4: Synthesis of unsupported aluminium oxyhydroxide (AlOOH): For the synthesis of unsupported AlOOH electrocatalyst, a similar synthesis condition was employed as for AlOOH/NGr, except the addition of GO.

### Example 5: Physical Characterization

Bulk morphological investigations and compositional information were investigated through field-emission scanning electron microscopy (FE-SEM) using FEI Nova Nano SEM 450 FE-SEM instrument. FEI, TECNAI G2 F-20 transmission electron microscopy (TEM) instrument at an accelerating voltage of 200 kV was used for the nanostructural imaging. FESEM samples were prepared by dispersing the obtained material in isopropyl alcohol (IPA) (5 mg of sample in 1 ml IPA) via bath-sonication; then the dispersed sample was coated on a silicon wafer. The sample was dried for 1 h under an IR lamp. High-resolution imaging and HAADF-STEM mapping were performed using a JEOL JEM F-200 HRTEM instrument. The samples for TEM and HRTEM analysis were prepared by dropwise coating of the well-dispersed sample in isopropyl alcohol (1.0 mg of the sample in 5 mL IPA) over a carbon-coated 200 mesh copper grid. The drying of the TEM grid was performed by exposing under an IR lamp for 1 h. To unravel the crystallinity and phase purity characteristics of the as-prepared samples, X-ray diffraction (XRD) analysis was performed on a Rigaku Smart Lab X-ray diffractometer (Cu Kα radiation (λ=1.5406 Å); scan rate of 2° min−1; 2θ range of 10 to 80o). Raman spectral investigations were performed using 632 nm green laser (NRS 1500 W) on a HR 800 RAMAN spectrometer. Active material loading in the NGr-supported samples was investigated by using thermogravimetric analysis (TGA) (SDT Q600 DSC-TDA thermo-gravimetric instrument; temperature range of 10-900° C.; ramp of 10 min-1° C.; oxygen atmosphere). The information on the presence of the elements, their respective chemical environments, and binding energy was gathered with the help of X-ray photoelectron spectroscopy (XPS) experiments. A VG Micro-Tech ESCA 300° instrument was employed for the XPS measurements.

Electrochemical Analysis: Electrochemical experiments required for the present study were carried out using a Bio-Logic potentiostat (model VMP-3). A set of electrochemical techniques such as rotating disk electrode (RDE), rotating ring disk electrode (RRDE), cyclic voltammetry (CV), linear sweep voltammetry (LSV) etc. were employed for collecting various information pertaining to the electrochemical characteristics of the materials. The tests were performed in a standard three-electrode system consisting of a catalyst-coated glassy carbon electrode (GCE, a diameter of 0.19625 mm), graphite rod and a saturated Hg/HgO as the working electrode, counter electrode and reference electrode, respectively.

Rotating Disk Electrode Study: The electrochemical performance was evaluated by performing a set of electrochemical techniques, including cyclic voltammetry (CV) and linear sweep voltammetry (LSV) using a Pine Instrument in the RDE mode. First, a three-electrode electrochemical cell was used to study the half-cell reactions with an SP-300 model Bio Logic potentiostat. The as-synthesized catalysts were coated over a working electrode by making a catalyst ink followed by its coating on the electrode. The Hg/HgO was used as a reference electrode and a graphite rod (Alfa Aesar, 99.99%) was employed as a counter electrode. ORR activity measurement was performed in oxygen-saturated aqueous 0.1 M KOH solution. Pt/C was employed as the reference catalyst for comparing the ORR performance. The catalyst slurry was prepared by mixing the catalyst (5 mg) in 1 mL isopropyl alcohol-water (1:2) solution and 40 μL of Nafion solution (5 wt %, Sigma-Aldrich) using water-bath sonication for approximately 1 h. After the formation of catalyst slurry, the 10 μL of the slurry (final loading of catalyst=50 μg cm−2) was drop-casted on the surface of the glassy carbon electrode (0.196 cm⁻²), which was polished with 0.3 μm alumina slurry in DI-water followed by cleaning with DI-water and acetone. The electrode was subsequently dried under an IR-lamp for 1 h. All the experimental electrode potentials were converted into the reversible hydrogen electrode (RHE) scale through an RHE calibration experiment which is given provided below.

Rotating Ring Disk Electrode Study: In the case of the RRDE analysis of the prepared catalysts, the catalyst coated disc electrode of the RRDE was scanned at a scan rate of 10 mV s⁻¹ while keeping the ring electrode at a constant potential of 0.40 V vs. Hg/HgO. At first, collection efficiency (N) at the ring was determined with a K₃Fe(CN)₆ solution, which is found to be 0.373. The calculation of H₂O₂% and the number of electron transfer (n) during the ORR was carried out by following the equations below:

$$\% hydrogen peroxide = 200 \times ( {I}_{R} * N ) / ( {I}_{D} + {I}_{R} / N )$$

$$n = 4 \times {I}_{D} / ( {I}_{D} + {I}_{R} / N )$$

where,
ID=Faradaic current at the disk
IR=Faradaic current at the ring
N=H₂O₂ collection efficiency of the ring electrode

All the electrochemical experiments were carried out at room temperature.

The Hg/HgO reference electrode calibration and conversion to RHE: The calibration of the Hg/HgO electrode has been performed by utilizing a 3-electrode setup consists of a platinum RDE electrode, graphite rod, and Hg/HgO as the working electrode (WE), counter electrode (CE), and reference electrode (RE), respectively, in an H2-saturated 0.1M KOH electrolyte. The potential at which the current crossed the zero point during the linear sweep voltammogram (LSV) measurement at a scan rate of 0.50 mV/s was measured and this point has been taken as the thermodynamic potential for the calibration purpose. This potential was found to be 0.87 V, and, hence, the conversion of the voltage recorded as for Hg/HgO to the RHE scale has been done by using the following equation:

$$E ( RHE ) = E ( Hg / HgO ) + 0.87 V \qquad 1$$

Zinc-Air Battery (ZAB) Fabrication and Testing: Fabrication of the ZAB was performed by using a Zn foil and AlOOH/NGr as the anode and the cathode electrodes, respectively, and the testing was done in an in-house-built electrochemical cell. Subsequent to sonication of AlOOH/NGr for 35 min and probe sonication for 10 min in isopropyl alcohol, Fumion and DI water solution, the catalyst slurry was coated on the gas diffusion layer (GDL). The catalyst loading was maintained as 1.0 mg/cm² (electrode area=1.0 cm²), and the catalyst-coated GDL was dried at 60° C. for 12 h. The as-obtained cathodes and the Zn anode were cut into 1*3 cm² areas; with the help of a Teflon tape, an exposed electrode area of 1*1 was maintained for the measurements. Finally, the ZAB was assembled by pairing the anode and cathode using 6.0 M KOH, where only 1*1 cm² of the active electrodes was allowed to expose. The ZAB setup was subsequently tested at room temperature using a multichannel SP-300 model Bio-Logic potentiostat/galvanostat. The battery was analyzed by steady-state polarization measured with same setup under continuous purging of oxygen at potential scan rate of 5 mV s⁻¹0.2

Computational study: A computational study has been carried out to support our claim of strong interaction between AlOOH and NGr via doped nitrogen as well as the controlled interplay between the surface texture and electronic factors favoring the ORR performance. To understand the effect of N doping on the interaction of AlOOH with rGO/NGr, we investigated the adsorption of AlOOH on these two systems. We placed an AlOOH molecule at three different positions on pristine graphene, viz, top of the carbon, bridge of the two carbons, and center of the hexagonal ring. The center position is thermodynamically the most favourable followed by the on-top position. The energy difference between these two positions is marginal (0.03 eV); however, the molecule gets physiosorbed when placed at the center (shown in FIG. 12a) and chemisorbed when placed at the on-top position (FIG. 12b). Eads and Al—C bond lengths for these two cases are also noted in FIG. 12. The AlOOH placed at the bridge site also diffuses to the top upon optimization. In case of NGr, the AlOOH is placed at three distinct positions. viz., top, bridge, and center of the pyridinic ring as shown in FIGS. 12c and d. thermodynamically, the most stable position is the one where AlOOH is near the void [shown in FIG. 12c] with the Al coordinating to three C and one N atoms. When placed above the center of the pyridinic ring, AlOOH physiosorbs on NGr with very weak interaction as rejected in the values corresponding to Eads and Al—C/Al—N bond lengths.

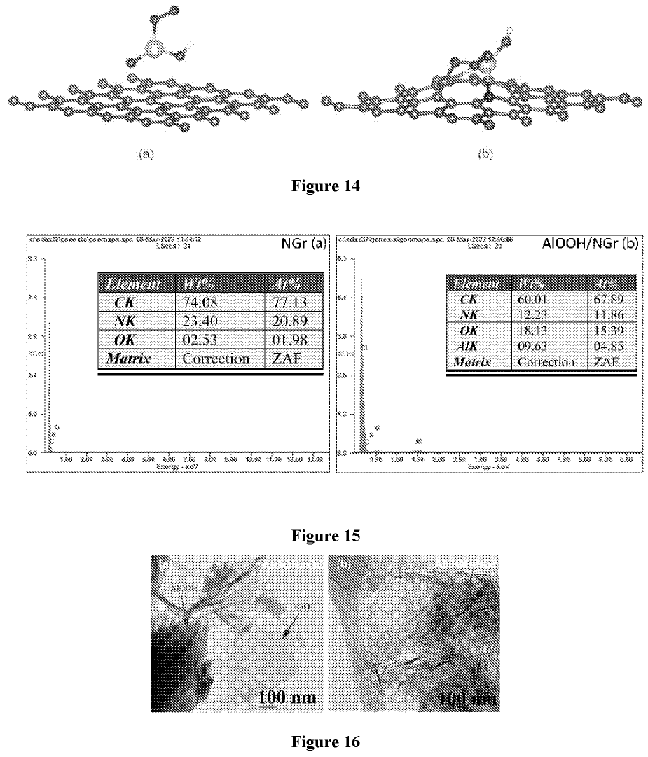

Next, we analyzed the Mulliken charges of Al, C, and N of the AlOOH/rGO and AlOOH/NGr systems. Due to the presence of nitrogen in graphene, AlOOH binds strongly to NGr, which is rejected in the bond lengths of Al—N and Al—C. This strong interaction of Al and N can also be observed from the charge distribution. The effective positive charge on Al increases (from 1.70 to 2.08), indicating more charge transfer from the Al in NGr as compared to pristine graphene. The projected density of states (pDOS) for Al(3p) in pristine graphene and NGr clearly brings out the difference between the interaction of AlOOH with both rGO and NGr and is shown in FIG. 13. In the case of the AlOOH placed on rGO, the 3p orbital of Al (shown in red color) has a sharp peak near the Fermi level. The Al, in the case of AlOOH/rGO, is coordinated with only one carbon atom and the pDOS indicates dominantly the ionic nature between the Al and rGO. A sharp contrast to this is observed in the case of the AlOOH/NGr system, where the pDOS of Al(3p) (shown in blue) is much broadened, indicating the covalent nature of the bonding. We also investigated the interaction of O₂ molecules with both the systems to understand the effect of N doping on the interaction of the catalyst towards the ORR. We observed that the adsorption of O2 on AlOOH/Gr results in the desorption of AlOOH from the graphene surface as shown in FIG. 6a. This could be explained as a consequence of higher affinity of Al towards oxygen as compared to carbon. However, when O₂ adsorbs on the AlOOH/NGr system, it results in the activation of the O₂ molecule by more than 6% with the AlOOH moiety still attached to the surface as shown in FIG. 14b.

SEM Mapping: FIGS. 15a and b display the EDX-SEM mapping data of NGr and AlOOH/NGr to estimate the average doping level of N on r-GO. The comparative finding shows the presence of all the concerned elements and that the average doping level of N in r-GO is ˜21% and in AlOOH/NGr is ˜12%.

TEM analysis: FIGS. 16a and b, represent the TEM images of AlOOH/rGO, indicating the presence of the bulk and agglomerated lumps of AlOOH. This is mainly caused by the poor anchoring and lack of nucleating sites over the rGO. In contrast to AlOOH/rGO, AlOOH/NGr shows thin and discrete anchoring of ellipsoid-like AlOOH dispersion over NGr, exhibiting the important role played by N-doping toward the development of our presented catalyst. Electrochemical analysis of the catalysts: Furthermore, to check the extent of the interaction between NGr and AlOOH, the time and temperature-dependent preparation of AlOOH/NGr was performed. When the synthesis time increases from 6 to 12 h, a noticeable performance enhancement has been observed, which is found to be declined when the reaction duration extended to 18 h (FIG. 17a). The ORR performance has also displayed significant changes with respect to the synthesis temperature. At the fixed synthesis duration of 12 h, AlOOH/NGr prepared at 180° C. is found to be clearly outperforming the one prepared at 120° C. with respect to the ORR activity (FIG. 17b). For better clarity, the onset and E_{1/2} values recorded on the different catalysts prepared under the abovementioned conditions are extracted and presented in Table 4. To understand the route of oxygen reduction kinetics involving the desired 4-electron (4e−) or the undesirable 2-electron (2e−) process, the rotating ring-disc electrode (RRDE) experiment was performed, and the electron transfer number (n) as well as the amount of H₂O₂ formed as a result of the 2e− reduction process have been estimated.

TABLE 4
Onset (E) and half-wave (E_{1/2}) potentials recorded for the
time and temperature dependent synthesized catalysts.

| | Onset Potential | Half-wave Potential |
|---|---|---|
| AlOOH/NGr | (E) | (E_{1/2}) |
| 120° C./12 h | 0.79 V | 0.55 V |
| 180° C./6 h | 0.84 V | 0.62 V |
| 180° C./12 h | 0.83 V | 0.72 V |
| 180° C./18 h | 0.78 V | 0.78 V |

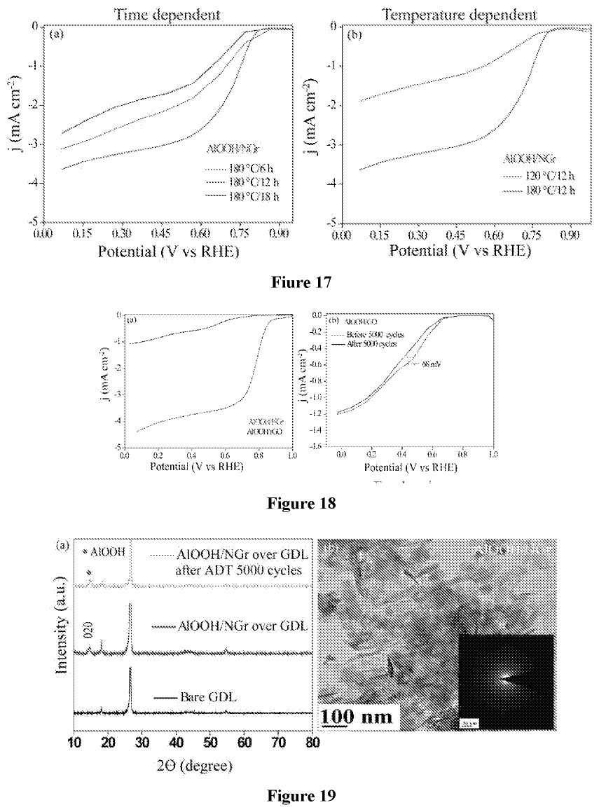

LSV profiles of AlOOH/NGr and AlOOH/rGO: In addition, the activity difference between AlOOH/rGO (without the N anchoring sites) and the AlOOH/NGr (with the N anchoring sites) also gives evidence of the favorable electron transport witnessed in AlOOH/NGr. FIG. 18a, represents the comparative LSVs recorded under O₂ atmosphere at 1600 rpm of the working electrode. As depicted in the figure, AlOOH/NGr showed much better ORR performance compared to that of AlOOH/rGO. Also, AlOOH/rGO is found to be less durable (FIG. 18) compared to AlOOH/NGr. Thus, this study experimentally supports the important role played by the doped N sites in the Gr matrix for establishing strong active center-substrate interaction as well as tuned favorable electronic property modulations towards ORR.

For analyzing the phase of the cycled catalyst, we have coated AlOOH/NGr over the GDL and performed ADT for 5000 cycles by following the same protocol as given in the ‘Electrochemical Analysis Section’ of Supporting Information. After the ADT, the catalyst coated GDL was subjected to XRD analysis. For comparison, the bare GDL and the GDL-coated catalysts before the ADT were also investigated. FIG. 19a, represents the comparative XRD patterns of all three samples. It can be seen that the peak corresponding to the (020) plane of AlOOH present at the 2Θ value of 14.5° is retained even in the post-ADT AlOOH/NGr sample, which confirms the ability of the system to survive under the harsh conditions of ADT. The surface texture of the cycled catalysis also has been analyzed via TEM analysis. FIG. 19b, represents the TEM image of the cycled catalyst, with the SAED pattern presented in the inset of the image. Apparently, the cycled catalyst shows more or less similar morphological features as that of the pristine catalyst except there is an indication of slight coverage of the surface with an amorphous phase. This amorphous phase could be due to the over-exposure of the AlOOH phase under the electrochemical conditions, which is in line with the XRD results.

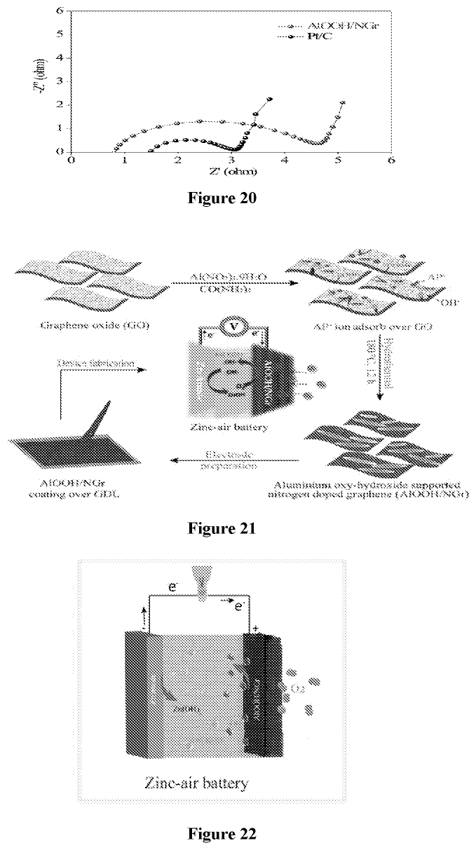

The trend obtained during the single-electrode studies for ORR could be reproduced effectively during the demonstration of a full-cell liquid-state ZAB system by employing AlOOH/NGr as the air electrode (cathode). The EIS analysis was performed at OCV condition in the frequency region of 200 kHz to 100 mHz with a sinusoidal voltage of 10 mV. As given in FIG. 20, the comparative spectra point towards the lower high-frequency resistance (HFR) of AlOOH/NGr, even though the state-of-the-art Pt/C catalyst has an advantage in terms of the charge transfer kinetics.

Mechanical rechargeability: The nearly flat discharge profile recorded by the AlOOH/NGr-based device is a promising aspect of the system concerning the device level durability and reliability from a practical operational perspective. Further, the long-term durability characteristics of the designed catalyst have been validated by performing the demonstration in the mechanically recharging mode of the battery. This is executed by replacing the consumed Zn anode after the discharging of the ZAB with a fresh Zn foil (anode) and keeping all the other components intact as described in FIG. 21, via pictorial representation.

TABLE 5
Onset (E) and half-wave (E_{1/2}) potentials
recorded for various synthesized catalysts.

| | Onset Potential | Half-Wave Potential |
|---|---|---|
| Sample | (V vs. RHE) | (V vs. RHE) |
| NGr | 0.70 V | 0.54 V |
| AlOOH/NGr | 0.83 V | 0.72 V |
| Pt/C | 0.98 V | 0.84 V |

### Advantages of the Invention

Fine distribution of AlOOH as nanosheets facilitated by doped nitrogen in NGr.
Enhanced ORR performance of AlOOH/NGr, compared to the interacting moieties, viz., NGr and AlOOH, as independent entities.
Simple, environmentally-benign and one-pot hydrothermal method of synthesis.
Cheaper cost of material contributes to the economic significance of AlOOH/NGr system.

1-12. (canceled)

13. A transition metal-free electrocatalyst composite comprising aluminum oxyhydroxide/nitrogen-doped graphene (AlOOH/NGr), wherein:
monodispersed aluminium oxyhydroxide (AlOOH) sheets are anchored over an electronically conducting nitrogen-doped graphene (NGr);
the AlOOH/NGr comprises a thin layered phase of AlOOH nanosheets uniformly distributed over NGr;
the AlOOH/NGr comprises aluminum, oxygen, nitrogen, and carbon;
aluminum and oxygen are distributed in a leaf-like shape in the AlOOH/NGr; and
nitrogen and carbon are distributed uniformly in the AlOOH/NGr.

14. The transition metal-free electrocatalyst composite according to claim 13, comprising, based on a total weight of the transition metal-free electrocatalyst composite:
from 6.2% to 9.7% by weight aluminum;
from 14.9 to 18.1% by weight oxygen; and
from 7% to 12.2% by weight nitrogen.

15. The transition metal-free electrocatalyst composite according to claim 13, wherein the AlOOH/NGr has an oxygen reduction reaction onset potential of 0.83 V and a half-wave potential of 0.72±2 V.

16. The transition metal-free electrocatalyst composite according to claim 13, wherein the AlOOH/NGr has mesoporosity from about 5 nm to about 10 nm and from about 12 nm to about 32 nm.

17. The transition metal-free electrocatalyst composite according to claim 13, wherein the AlOOH nanosheets have widths from about 150 nm to about 200 nm.

18. A one pot hydrothermal process for synthesizing the transition metal-free electrocatalyst composite according to claim 13, the one pot hydrothermal process comprising:
(a) dispersing graphene oxide in water via water-bath sonication followed by addition of Al(NO₃)₃·9H₂O and urea under stirring to obtain a dispersion comprising from 60% to 65% by weight graphene oxide and from 35% to 40% by weight Al(NO₃)₃·9H₂O; and
(b) hydrothermally heating the dispersion of (a) followed by cooling to room temperature, washing with water, subsequently washing with ethanol, and drying, to obtain AlOOH/NGr.

19. The process according to claim 18, wherein:
the hydrothermal heating in (b) is carried out at 180° C. for 12 hours; and
the drying in (b) is carried out at 55° C.

20. The process according to claim 18, wherein the dispersion in (a) comprises 5% by weight urea.

21. An air electrode comprising the transition metal-free electrocatalyst composite according to claim 13.

22. The air electrode according to claim 21, wherein the electrode is cathode and composed of AlOOH/NGr, wherein the air electrode of AlOOH/NGr electrocatalyst maintains its performance under four times mechanical recharging of the battery and lasts longer than 35 hours at a discharge current density of 10 mA cm⁻².

23. An energy storage device comprising the air electrode according to claim 21.

24. The energy storage device according to claim 23, wherein the device is a metal-air battery comprising a metal chosen from zinc, aluminum, or magnesium.
